(19) United States
(12) Patent Application Publication
(10) Pub. No.: US 2005/0177842 A1
(43) Pub. Date: Aug. 11, 2005

(54) Multi-stack optical data storage medium and use of such medium

(75) Inventor: Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklije Philips Electronics N.V., 5621 BA EIndhoven (NL)

(21) Appl. No.: 10/520,869

(22) PCT Filed: Jun. 20, 2003
(86) PCT No.: PCT/IB03/02956

(51) Int. Cl. G11B 7/24; G11B 23/03

(52) U.S. Cl. 720/718

(57) ABSTRACT

A multi-stack optical data storage medium (20) for rewritable recording using a focused radiation beam (19) entering through an entrance face (16) of the medium (20) during recording is described. The medium (20) comprises a substrate (1) with deposited on a side thereof a first stack (2) L₀ comprising a first phase-change type recording layer (6). The first recording stack (2) is present at a position most remote for the entrance face (16). At least one further recording stack (3)Lₙ, which comprises a further phase-change type recording layer (12), is present closer to the entrance face (16) than the first recording stack (2). A transparent spacer layer (9) is present between the recording stacks (2, 3). The further recording layer (12) is substantially of an alloy defined by the formula GeₓSb_{y}Te_{z} in atomic percentages, where 0<x<15, 50<y<80, 10<z<30 and x+y+z=100 with a thickness selected from the range of 4 to 12 nm and has at least one transparent crystallization promoting layer (11′, 13′) having a thickness smaller than 5 nm in contact with the further recording layer (12). A high optical transmission combined with a low crystallization time of the recording layer (12) of the Lₙ stack (3) is achieved making the medium (20) suitable for multi-stack high speed recording with a linear recording velocity of at least 12 m/s.

The invention relates to a multi-stack optical data storage medium for rewritable recording using a focused radiation beam entering through an entrance face of the medium during recording, comprising:
a substrate with deposited on a side thereof:
a first recording stack L₀ comprising a first phase-change type recording layer, said first recording stack being present at a position most remote from the entrance face,
at least one further recording stack Lₙ, which comprises a further phase-change type recording layer, being present closer to the entrance face than the first recording stack,
a transparent spacer layer between the recording stacks, said transparent spacer layer having a thickness larger than the depth of focus of the focused radiation beam.

The invention also relates to the use of such an optical recording medium in high-speed applications.

An embodiment of an optical data storage medium of the type mentioned in the opening paragraph is known from U.S. Pat. No. 6,190,750, filed by Applicants.

An optical data storage medium based on the phase-change principle is attractive, because it combines the possibilities of direct overwrite (DOW) and high storage density with easy compatibility with read-only optical data storage systems. Data storage, in this context, includes digital video-, digital audio- and software-data storage. Phase-change optical recording involves the formation of submicrometer-sized amorphous recording marks in a crystalline recording layer using a focused relatively high power radiation beam, e.g. a focused laser-light beam. During recording of information, the medium is moved with respect to the focused laser-light beam that is modulated in accordance with the information to be recorded. Marks are formed when the high power laser-light beam melts the crystalline recording layer. When the laser-light beam is switched off and/or subsequently moved relatively to the recording layer, quenching of the molten marks takes place in the recording layer, leaving an amorphous information mark in the exposed areas of the recording layer that remains crystalline in the unexposed areas. Erasure of written amorphous marks is realized by recrystallization through heating with the same laser at a lower power level without melting the recording layer. The amorphous marks represent the data bits, which can be read, e.g. via the substrate, by a relatively low-power focused laser-light beam. Reflection differences of the amorphous marks with respect to the crystalline recording layer bring about a modulated laser-light beam which is subsequently converted by a detector into a modulated photocurrent in accordance with the recorded information.

One of the most important requirements in phase-change optical recording is a high data rate, which means that data can be written and rewritten in the medium with a user data rate of at least 30-50 Mbits/s. A high data rate is particularly required in high-density recording and high data rate optical recording media, such as in disk-shaped CD-RW high speed, DVD-RW, DVD+RW, DVD-RAM, DVR-red and DVR-blue, also called Blu-ray Disk (BD), which respectively are abbreviations of the known Compact Disk and the new generation high density Digital Versatile or Video Disk+RW and −RAM, where RW and RAM refer to the rewritability of such disks, and Digital Video Recording optical storage disks, where red and blue refer to the used laser wavelength. Such a high data rate requires the recording layer to have a high crystallization speed, i.e. a crystallization time of lower than 30 ns, during DOW. This also applies to the recording layers of multi-stack versions of mentioned disks. For DVD+RW, a user data bit rate of 33 Mbit/s is needed and for DVR-red 35 Mbit/s and for DVR-blue 50 Mbit/s (a CET of 35 ns) or even higher for higher speed versions. The complete erasure time (CET) is defined as the minimum duration of an erasing pulse for complete crystallization of a written amorphous mark in a crystalline environment. The CET is generally measured with a static tester. The AV-information stream determines the data rate for Audio/Video (AV)-applications but for computer-data applications no restrictions in data rate apply, i.e. the higher the better. Each of these data bit rates can be translated to a maximum CET which is influenced by several parameters, e.g. thermal design of the recording stacks and the recording layer materials used.

To ensure that previously recorded amorphous marks can be recrystallized during DOW, the recording layer must have a proper crystallization speed to match the velocity of the medium relative to the laser-light beam during DOW, i.e. the linear recording velocity. If the crystallization speed is not high enough the amorphous marks from the previous recording, representing old data, cannot be completely erased, meaning recrystallized, during DOW. On the other hand, when the crystallization time is short, amorphization becomes difficult because crystallite growth from the crystalline background is unavoidable. This results in relatively small amorphous marks (low modulation) with irregular edges, causing a high jitter level. This limits the density and data rate of the disk. Therefore a stack with a relatively high cooling rate of the recording layer is highly desired.

Another important requirement for optical data storage media is the data storage capacity. Applying multiple recording stacks may increase this capacity. Multi-stack designs may be represented by a symbol Lₙ in which n denotes 0 or a positive integer number. In this document, the “further” stack through which the radiation beam enters is called Lₙ, while each deeper stack is represented by Lₙ₋₁ . . . L₀. Deeper is to be understood in terms of the direction of the incoming radiation beam. Note that in other documents this notation may be reversed and that L₀ represents the stack closest to the entrance face and Lₙ the stack farthest form the entrance face. Thus in case of a dual stack design two stacks L₀ and L₁ are present. L₁ has to be substantially transparent to the radiation beam in order to make recording in the deepest “first” stack (L₀) possible. However, a Lₙ stack with layers that combines a relatively high transparency with still sufficient cooling and recording properties is difficult to obtain. In multi-stack optical phase-change recording it is difficult to fulfil the high cooling rate requirement for the further recording stack because of the absence of a transparent layer with sufficient cooling capability in the further recording stacks. Furthermore, the recording layer of the further recording stack itself may not be too thin because this may cause a high crystallization time of said recording layer.

Said known medium of U.S. Pat. No. 6,190,750 has a |IP₂IM₂I⁺|S|IP₁IM₁| structure for rewritable phase-change recording which has two metal reflective layers M₁ and M₂, which respectively are relatively thick, with a high optical reflection, and relatively thin, with a relatively high optical transmission and substantial thermal conductivity. I represents a dielectric layer, I⁺ represents a further dielectric layer. P₁ and P₂ represent phase-change-recording layers, and S represents a transparent spacer layer. In this structure the laser-light beam enters first through the stack containing P₂. The metal layers not only serve as a reflective layer, but also as a heat sink to ensure rapid cooling for quenching the amorphous phase during writing. The P₁ layer is present proximate a relatively thick metal mirror layer M₁ which causes substantial cooling of the P₁ layer during recording while the P₂ layer is present proximate a relatively thin metal layer M₂ with limited heat sink properties. As already explained, the cooling behavior of a recording layer determines to a large extent the correct formation of amorphous marks during recording. Sufficient heat sink action is required in order to ensure proper amorphous mark formation during recording.

In order to enhance the transmission of the L₁ stack, additional thin M and I layers were introduced in the known medium from U.S. Pat. No. 6,190,750. Stoichiometric or compound Ge—Sb—Te materials, e.g. Ge₂Sb₂Te₅, are used as the recording layer for the known recording medium, e.g. DVD-RAM disks. These stoichiometric compositions (region 31 of FIG. 3) have a nucleation-dominated crystallization process. It means that the erasure of a written amorphous mark occurs by nucleation in the mark and subsequent growth. A relatively high optical transmission of the recording layer can only be achieved when its thickness is lower than 15 nm. However, the data rate of the recording layer of the L₁ stack is very low because the complete erasure time (CET) of these GeSbTe compound materials is larger than 500 ns at a thickness of 8 nm or smaller and is shortened to 300 ns when is sandwiched between two thin SiC layer. Still these values are unacceptably high. For multi recording layer applications it is desirable that the recording layers, which are closest to the entrance face of the recording/reading laser-light beam, have a relatively high optical transmission, hence a relatively low thickness, in order to allow writing and reading in underlying recording layers combined with a low CET.

It is an object of the invention to provide a rewritable optical storage medium of the kind described in the opening paragraph, having a further recording layer with a relatively high optical transmission corresponding to a thickness of the further recording layer of lower than 12 nm, and a CET of maximum 35 ns, making it suitable for high speed recording. High-speed recording is to be understood as recording at a linear recording velocity, i.e. the velocity of the focused radiation beam relatively to optical data storage medium, of at least 12 m/s.

This object is achieved in accordance with the invention by an optical storage medium, which is characterized in that the further recording layer is substantially of an alloy defined by the formula GeₓSb_{y}Te_{z} in atomic percentages, where 0<x<15, 50<y<80, 10<z<30 and x+y+z=100 with a thickness selected from the range of 4 to 12 nm and that at least one transparent crystallization promoting layer having a thickness smaller than 5 nm is present in contact with the further recording layer.

These materials can be considered as the area surrounding and including the eutectic Sb₇₀Te₃₀ doped with Ge and have a growth-dominated crystallization process. It means that mark erasure occurs by direct growth from the edge between the written amorphous mark and crystalline background. Nucleation within the written amorphous mark does not occur before this growth finished. The CET of these materials first decreases rapidly with increasing the layer thickness and then increases again upon further increasing layer thickness. The shortest crystallization time is found at a thickness of about 10 nm.

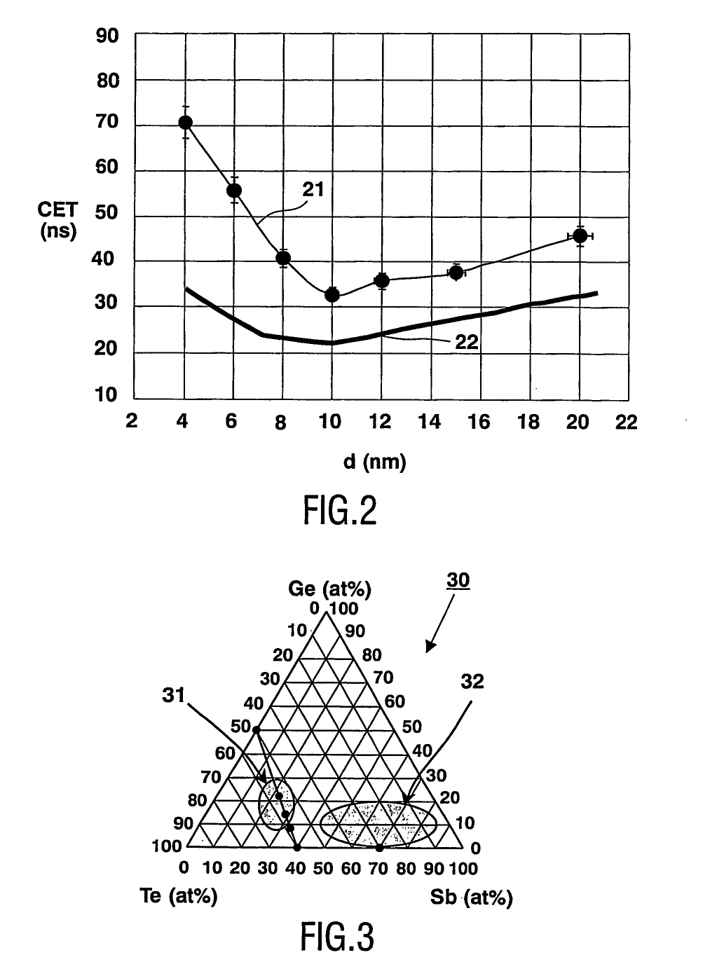

In non-prepublished European patent application 02075496.6 CPNLO20099), filed by Applicants, a thickness range between 7 and 18 nm is proposed for use in high data rate and high density optical recording systems, such as DVD+RW, DVR-red and -blue. These “eutectic” (growth type) materials are most suitable for high data rate and high density recording in both single and dual layer DVD and DVR, also called Blu Ray Disk (13D), recording systems because the crystallization time decreases with the decrease of the recording amorphous mark size. “Eutectic” refers to eutectic Sb₇₀Te₃₀ and to substantially the area 32 as drawn in FIG. 3. For a higher recording density, dual layer or multi layer DVD, DVR systems are highly desired because the recording density can be doubled or more. In the L₁ stack of a dual layer DVD/DVR disk, the thickness of the recording layer should be as thin as possible, preferably about 5 nm, to allow a high transmission. The shortest CET of doped “eutectic” Sb—Te (growth-type) recording materials is obtained at about 10 nm. A short CET at a still thinner layer is required. It is proposed to use the eutectic Ge-doped SbTe as recording layer, which is in contact with a crystallization promoting layer and preferably sandwiched between two crystallization promoting layers such as nitrides, oxides of Si, Al and Hf. The use of crystallization promoting layers is to enhance the crystallization rate of the recording layer, leading to a CET of about 30 ns at a thickness of about 5 nm and a recording-layer composition of Ge_{7.0}Sb_{76.4}Te_{16.6}. The low-CET window is also improved (see FIG. 2).

The thickness dependence of the crystallization time of these “eutectic”—GeSbTe compositions may be understood as follows: the strong decrease of the CET with the increase of the phase change layer thickness is a result of competition between the contributions of the interface material and the bulk material. When the layer is relatively thin, the volume fraction of the material located at the interface is large, which is often structurally very different from its bulk form, e.g. has more defects. With the increase of layer thickness, the fraction of the material that is in bulk form will increase, and above a certain thickness the bulk form will govern the behavior of the material. Apparently, the bulk materials have a more favorable growth speed than the interface materials. The increase of the CET with the phase change layer thickness may be caused by the volume increase of the material. The crystallization process of a Ge—Sb—Te layer according to claim 1 is growth-dominated. The volume of the material to be crystallized becomes important. The size of the crystallites is typically 10 nm. When the layer becomes thicker, a three-dimensional growth is required, naturally a longer time needed. When the layer is thin, a two-dimensional growth is needed, which needs a shorter time.

However, when the recording layer becomes too thin, e.g. a few nm, the interface plays a dominant role and may reduce the growth speed. The improvement of the interface results in a significant enhancement of crystallization speed.

Preferably, the transparent crystallization-promoting layer mainly comprises a material selected from the group of nitrides, oxides of Si, Al and Hf and even more preferably a material selected from the group of nitrides of Al and nitrides of Si. Nitrides of Al and Si, e.g. Si₃N₄, have a very good crystallization promoting behavior.

In a favorable embodiment of the optical storage medium according to the invention the further recording layer has a thickness selected from the range of 4 to 8 nm. At the lower end of this range an optical transmission of the L₁-stack may be achieved which is larger than 50%.

In another favorable embodiment of the optical storage medium according to the invention the alloy has a composition defined by the formula GeₓSb_{y}Te_{z} in atomic percentages, where 5<x<8, 70<y<80, 15<z<20 and x+y+z=100. A recording layer with a composition in this range has proven to give excellent CET values as low as 25 ns at an optimal thickness of 10 nm.

In a further embodiment a metal reflective layer, semi-transparent for the radiation beam, is present in the further recording stack. This reflective layer combines a relatively large heat conductivity with a relatively high optical transparency. The heat conductivity is advantageous for the amorphous mark formation process, especially when using growth dominated recording layer materials according to the invention. Especially Cu is preferred because it combines excellent heat conductivity with a relatively low chemical reactivity compared to for example Ag. A high heat conductivity is advantageous for cooling the recording layer of the recording stack.

Preferably the recording layer of the further recording stack and one or two crystallization promoting layers in contact with the further recording layer is sandwiched between further dielectric layers. An optimum thickness range for e.g. a dielectric layer between the recording layer and the metal reflective layer, is found between 3 and 30 nm, preferably between 4 and 20 nm. This dielectric layer may be used to tune the optical properties of the recording stack. When this layer is relatively thin, the thermal insulation between the recording layer and the metal reflective layer is decreased. As a result, the cooling rate of the recording layer is increased. Increasing the thickness of the dielectric layer will decrease the cooling rate.

An optimal thickness range for a further dielectric layer at a side of the recording stack closest to the entrance face is between 50 and 200 nm. When the first dielectric layer has a thickness lower than 50 nm the optical properties of the stack may be adversely affected. Thicknesses larger than 200 nm may cause stresses in the layer and are more expensive to deposit.

In a special embodiment of the optical storage medium according to the invention the first recording layer has the same composition as a further recording layer. The first recording may be sandwiched between dielectric layers similar to the dielectric layers of the further recording layer. Crystallization promoting layers in contact with the first recording layer may be present but are optional. The thickness of the first recording layer may be thicker than 12 nm because it does not need to have a high optical transparency.

The dielectric layers may be made of a mixture of ZnS and SiO₂, e.g. (ZnS)₈₀(SiO₂)₂₀. Alternatives are, e.g. SiO₂, TiO₂, ZnS, AlN and Ta₂O₅. Preferably the dielectric layers of the first recording stack comprises a carbide, like SiC, WC, TaC, ZrC or TiC. These materials may give a higher crystallization speed and better cyclability than a ZnS—SiO₂ mixture.

For the metal reflective layer, metals such as Al, Ti, Au, Ni, Cu, Ag, Cr, Mo, W, and Ta and alloys of these metals, can be used. The substrate of the data storage medium is at least transparent for the laser wavelength, and is made, for example, of polycarbonate (PC), polymethyl methacrylate (EMMA), amorphous polyolefin or glass. Transparency of the substrate is only required when the laser-light beam enters the recording stacks via the entrance face of the substrate. In a typical example, the substrate is disk-shaped and has a diameter of 120 mm and a thickness of 0.1, 0.6 or 1.2 mm.

The substrate may be opaque when the laser-light beam enters the stack via the side opposite from the side of the substrate. In the latter case the metal reflective layer of the stack is adjacent the substrate. This is also referred to as an inversed stack. An inversed stack is e.g. used in the DVR disk.

The surface of the disk-shaped substrate on the side of the recording stacks is, preferably, provided with a servotrack, which can be scanned optically. This servotrack is often constituted by a spiral-shaped groove and is formed in the substrate by means of a mould during injection molding or pressing. These grooves can be alternatively formed in a replication process in the synthetic resin of the spacer layer, for example, a UV light-curable acrylate.

Optionally, the outermost layer of the stack is screened from the environment by means of a protective layer of, for example, UV light-cured poly(meth)acrylate. The protective layer must be of good optical quality, i.e. substantially free from optical aberrations and substantially uniform in thickness, when the laser-light enters the recording stacks via the protective layer. In this case, the protective layer is transparent to the laser-light and is also called cover layer. For DVR disks this cover layer has a thickness of 0.1 mm.

Recording and erasing data in the recording layers of the recording stacks may be achieved by using a short-wavelength laser, e.g. with a wavelength of 660 nm or shorter (red to blue).

Both the metal reflective layer, and the dielectric layers can be provided by evaporation or sputtering.

The phase-change recording layer can be applied to the substrate by vacuum deposition. Known vacuum deposition processes are evaporation (E-beam evaporation, resistant heat evaporation from a crucible), sputtering, low pressure Chemical Vapor Deposition (CVD), Ion Plating, Ion Beam Assisted Evaporation, Plasma enhanced CVD. Normal thermal CVD processes are not applicable because of too high reaction temperature. The layer thus deposited is amorphous and exhibits a low reflection. In order to constitute a suitable recording layer having a high reflection, this layer must first be completely crystallized, which is commonly referred to as initialization. For this purpose, the recording layer can be heated in a furnace to a temperature above the crystallization temperature of the Ge—Sb—Te alloy, e.g. 180° C. A synthetic resin substrate, such as PC, can alternatively be heated by a special laser-light beam of sufficient power. This can be realized, e.g. in a special recorder, in which case the special laser-light beam scans the moving recording layer. The amorphous layer is then locally heated to the temperature required for crystallizing the layer, without the substrate being subjected to a disadvantageous heat load.

High-density recording and erasing can be achieved by using a short-wavelength laser, e.g. with a wavelength of 670 nm or shorter (red to blue).

The invention will be elucidated in greater detail by means of exemplary embodiments and with reference to the accompanying drawings, in which:

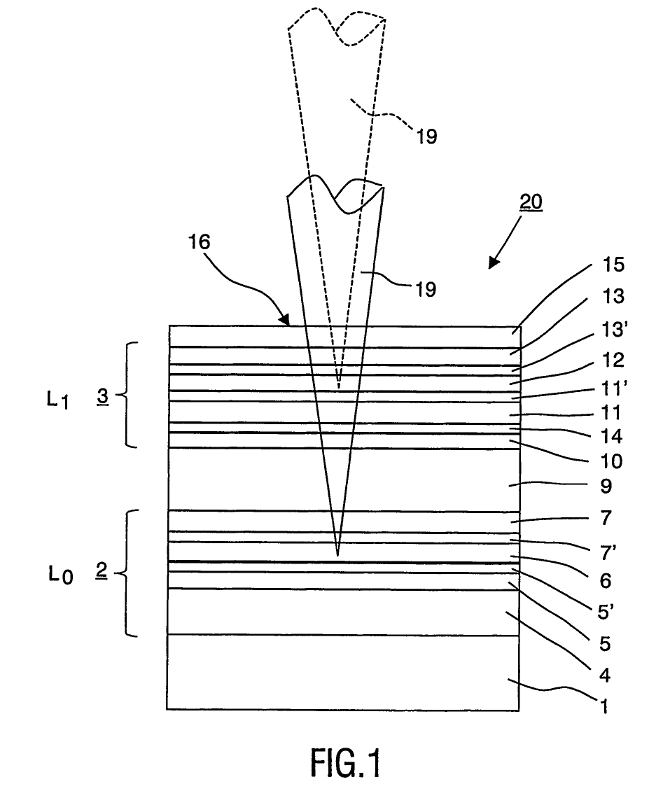

FIG. 1 shows a schematic cross-sectional view of an optical storage medium in accordance with the invention,

FIG. 2 shows the relation between CET (in ns) and the thickness d (in um) of the recording layer of the L₁ or L₀ stack for a GSb_{76.4}Te_{16.6} material with and without crystallization promoting layer,

FIG. 3 shows a ternary phase diagram for Ge—Sb—Te.

In FIG. 1 the multi-stack optical data storage medium 20 for rewritable recording is shown. A focused radiation beam 19, with a wavelength of 670 nm, enters through an entrance face 16 of the medium 20 during recording. The medium has a substrate 1 made of PC having a diameter of 120 mm and a thickness of 0.6 mm, with deposited on a side thereof a first recording stack 2 comprising a first phase-change type recording layer 6. The first recording stack 2 is present at a position most remote from the entrance face 16. A further recording stack 3, which comprises a further phase-change type recording layer 12, is present closer to the entrance face 16 than the first recording stack. A transparent spacer layer 9 is present between the recording stacks 2, 3. The transparent spacer 9 layer has a thickness of 30 μm and may be made of a UV curable resin known in the art provided by spin coating or a plastic sheet of e.g. PMMA or PC including a pressure sensitive adhesive (PSA) layer. The further recording layer 12 is substantially of an alloy defined by the formula Ge₇Sb_{76.4}Te_{16.6} in atomic percentages and has a thickness of 5 nm. Two transparent crystallization promoting layer 11′, 13′ having a thickness of 2 nm are present in contact with the further recording layer 12. The transparent crystallization promoting layers 11′, 13′ mainly comprise the material Si₃N₄. A metal reflective layer 14, semi-transparent for the radiation beam 19, is present in the further recording stack 3 and mainly comprises the element Cu and has a thickness of 6 nm.

Recording and reading is performed by means of a laser-light beam 19. Further dielectric layers 11 and 13 made of (ZnS)₈₀(SiO₂)₂₀ with thicknesses of 5 and 160 nm respectively are present. The thickness d of the recording layer 12 may be varied between 4 and 20 nm. Results of the effect of this variation on the CET are shown in FIG. 2.

The first recording layer 6 is substantially of an alloy defined by the formula Ge₇Sb_{76.4}Te_{16.6} in atomic percentages and has a thickness of 10 nm. Two optional transparent crystallization promoting layer 5′, 7′ having a thickness of 2 nm are present in contact with the first recording layer 6. The transparent crystallization promoting layers 5′, 7′ mainly comprise the material Si₃N₄. A second metal reflective layer 4 is present in the first recording stack 3 and mainly comprises the element Cu and has a thickness of 100 nm. Recording and reading is performed by means of a laser-light beam 19. Further dielectric layers 5 and 7 are present made of (ZnS)₈₀(SiO₂)₂₀ with thicknesses of 20 and 90 nm respectively. The thickness d of the recording layer 6 may be varied between 4 and 20 nm. Results of the effect of this variation on the CET are shown in FIG. 2.

The layer structure of the L₁ stack 3 of the medium of FIG. 1 described above may be summarized as follows:

I(160)-N(2)-P(5)-N(2)-I(5)-M(6)-I(80), in which notation I represent a dielectric layer 11 or 13, N a crystallization promoting layer 11′ or 13′, P the recording layer 12, M the metal layer 14 while the number between brackets represents the thickness in nm of each layer. With this design the following optical transmission (T), reflection (R) and contrast values of the L₁ stack 3 are obtained:

T_{c}=0.352 Tₐ=0.531 R_{c}=0.145 Rₐ=0.028, c and a denoting the phase, i.e. crystalline or amorphous, of the recording layer 12. Contrast=(R_{c}−Rₐ)/R_{c}=0.807.

In another embodiment, not drawn, the structure of L₁ may be:

I(60)-N(2)-P(5)-N(2)-M(6)-I(80). Note that, compared to FIG. 1, the dielectric layer 11 between the metal layer 14 and the crystallization promoting layer 11′ has been deleted. This deletion may increase the cooling behavior of the stack 3 because the distance between the recording layer 12 and the metal layer 14 has decreased. The deletion further influences the optical properties of the stack in terms of optical transmission, reflection and contrast. An advantage is that fewer layers are required, which is economical in manufacture. With this design the following optical transmission, reflection and contrast values of the L₁ stack 3 are obtained:

T_{c}=0.460 Tₐ=0.624 R_{c}=0.144 Rₐ=0.056. Contrast=(R_{c}−Rₐ)/R_{c}=0.611.

The phase-change recording layers 6 and 12 are applied to the substrate by vapor depositing or sputtering of a suitable target. The layers thus deposited is amorphous and is initialized, i.e. crystallized, in a special recorder also called initializer. Further layers, with the exception of spacer layer 9 and a cover layer 15 are also provided by vapor depositing or sputtering of a suitable target. The radiation beam 19 for recording, reproducing and erasing of information enters the recording layer 6 or 12 via the transparent cover layer 15. The transparent cover layer 15 has a thickness of 0.1 mm and is made of a UV cured resin provided by spin coating. The cover layer 15 may also be provided by application of a plastic sheet including a pressure sensitive adhesive (PSA) layer.

In FIG. 2 the dependence of the CET in ns on the thickness d in nrm of the phase-change recording layer 6 or 12 for the compound Ge₇Sb_{76.4}Te_{16.6} is shown. Graph 2I represents the relation without crystallization promoting layers and graph 22 represents the relation when the recording layer 6 or 12 is sandwiched between two crystallization promoting layers made of Si₃N₄ and having a thickness of 2 nm. From curve 21 it is clear that the CET has a minimum value at d=10 nm. Further it is clear that by applying crystallization promoting layers the CET stays below 35 ns even at a thickness of d=4 nm of the recording layer 6, 12.

In FIG. 3 the ternary phase diagram 30 has an area 32 which represents the “eutectic” GeₓSb_{y}Te_{z}(x+y+z=100) materials that are used as the recording layer for e.g. DVD+RW, DVR or BD disks and are far from the stoichiometric compositions in region 31. The materials with compositions from area 32 can be considered as the eutectic Sb₇₀Te₃₀ doped with Ge and have a growth-dominated crystallization process. It means that mark erasure occurs by direct growth from the edge between the written amorphous mark and crystalline background. Nucleation within the written amorphous mark does not occur before this growth finished. The CET of these materials first decreases rapidly with increasing the layer thickness and then increases again upon further increasing layer thickness as shown in FIG. 2. The shortest crystallization time is found at a thickness of about 10 nm. These eutectic (growth type) materials are most suitable for high data rate and high density recording in both single and dual layer DVD and DVR recording systems because the crystallization time decreases with the decrease of the recording amorphous mark size.

It should be noted that the above-mentioned embodiment illustrates rather than limits the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

According to the invention a multi-stack optical data storage medium for rewritable recording using a focused radiation beam entering through an entrance face of the medium during recording is described. The medium comprises a substrate with deposited on a side thereof a first recording stack L₀ comprising a first phase-change type recording layer. The first recording stack is present at a position most remote from the entrance face. At least one further recording stack Lₙ, which comprises a further phase-change type recording layer, is present closer to the entrance face than the first recording stack. A transparent spacer layer is present between the recording stacks. The further recording layer is substantially of an alloy defined by the formula GeₓSb_{y}Te_{z} in atomic percentages, where 0<x<15, 50<y<80, 10<z<30 and x+y+z=100 with a thickness selected from the range of 4 to 12 nm and has at least one transparent crystallization promoting layer having a thickness smaller than 5 nm in contact with the further recording layer. A high optical transmission combined with a low crystallization time of the recording layer of the Lₙ stack is achieved making the medium suitable for multi-stack high speed recording with a linear recording velocity of at least 12 m/s.

1. A multi-stack optical data storage medium (20) for rewritable recording using a focused radiation beam (19) entering through an entrance face (16) of the medium (20) during recording, comprising:
a substrate (1) with deposited on a side thereof:
a first recording stack (2) L₀ comprising a first phase-change type recording layer (6), said first recording stack (2) being present at a position most remote from the entrance face (16),
at least one further recording stack (3) Lₙ, which comprises a further phase-change type recording layer (12), being present closer to the entrance face (16) than the first recording stack (2),
a transparent spacer layer (9) between the recording stacks (2, 3), said transparent spacer (9) layer having a thickness larger than the depth of focus of the focused laser-light beam (19),
characterized in that the further recording layer (12) is substantially of an alloy defined by the formula GeₓSb_{y}Te_{z} in atomic percentages, where 0<x<15, 50<y<80, 10<z<30 and x+y+z=100 with a thickness selected from the range of 4 to 12 nm and that at least one transparent crystallization promoting layer (11′, 13′) having a thickness smaller than 5 nm is present in contact with the further recording layer (12).

2. An optical storage medium (20) as claimed in claim 1, wherein the transparent crystallization promoting layer (11′, 13′) mainly comprises a material selected from the group of nitrides, oxides of Si, Al and Hf.

3. An optical storage medium (20) as claimed in claim 2, wherein the transparent crystallization promoting layer (11′, 13′) mainly comprises a material selected from the group of nitrides of Al and nitrides of Si.

4. An optical storage medium (20) as claimed in claim 2, wherein the further recording layer (12) has a thickness selected from the range of 4 to 8 nm.

5. An optical storage medium (20) as claimed claim 1, wherein the alloy has a composition defined by the formula GeₓSb_{y}Te_{z} in atomic percentages, where 5<x<8, 70<y<80, 15<z<20 and x+y+z=100.

6. An optical storage medium (20) as claimed in any one of claims 1, wherein a metal reflective layer (14), semi-transparent for the radiation beam (19), is present in the further recording stack (3).

7. An optical storage medium (20) as claimed in claims 6, wherein the metal reflective layer (14) mainly comprises the element Cu.

8. Use of an optical storage medium (20) as claimed in claim 1, for high speed recording with a recording speed higher than 12 m/s.
